(19) United States
(12) Patent Application Publication
(10) Pub. No.: US 2003/0190139 A1
(43) Pub. Date: Oct. 9, 2003

(54) Data stream processor

(75) Inventors: Masao Ishiguro, Kawasaki (JP); Atsuo Kawaguchi, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/306,574

(22) Filed: Nov. 27, 2002

(30) Foreign Application Priority Data
Feb. 27, 2002 (JP) 2002-050669

(51) Int. Cl. H04N 5/76

(52) U.S. Cl. 386/46; 386/124; 386/111

(57) ABSTRACT

Disclosed is a data stream processor that allows both the coder side and the decoder side to obtain reference time information needed to generate a reference frequency from the same external reference time station, and uses the same frequency for encoding and decoding. The invention is particularly useful when a plurality of data streams data are received and decoded. A decoder side performs decoding at the same frequency as a reference frequency for each coder side that generated the stream data, because if the same frequency is not used for encoding, stream data will be lost or insufficient in a decoder's buffer for storing stream data. This causes errors such as repeating audiovisual data, missing frames, etc. When the reference time needed for the decoder side to adjust frequencies is embedded in each stream data, it is difficult to adjust frequencies for all the stream data.

### BACKGROUND OF THE INVENTION

The present invention relates to a data stream processor that performs processing such as encoding or decoding for data, particularly data including video and/or audio information.

The international standard MPEG2 (Moving Picture Experts Group 2) is one method for compressing audiovisual information. MPEG2 is a method that individually compresses video and audio and synchronizes and multiplexes the compressed video, audio, data, etc. MPEG2 is suitable for storage media, networks, etc. There are two types of MPEG2: MPEG2-PS (Program Stream) for multiplexing and demultiplexing a single program and MPEG2-TS (Transport Stream) for a plurality of programs. MPEG2-TS can handle a plurality of program data as a sequence of data (hereafter referred to as a “data stream”) and is mainly used for television broadcasting services.

Data to be compressed by MPEG2-TS includes a Decoding Time Stamp (DTS) and Presentation Time Stamp (PTS) for times of decoding and presenting each frame of video and audio information. Further, compressed data include two types of time information: System Clock Reference (SCR) and Program Clock Reference (PCR). These types of information are used for a decoder to decode compressed data (hereafter simply referred to as “decoder”). The decoder uses SCR and PCR to correct a System Time Clock (STC) value to an intended value for a coder to compress data (hereafter simply referred to as “coder”).

Unless the decoder uses the PCR to correct the STC, the decoder's STC gradually deviates from the coder's system clock. When the decoder's STC precedes the coder's system clock, the decoder starts decoding or reaches the reproduction time before complete arrival of a data stream from the coder, i.e., with a temporary empty state of a buffer that should store data streams including audiovisual data. Namely, the decoder repeats the same video or audio. On the other hand, when the decoder's STC follows the coder's system clock, the decoder causes a delay in timing for decoding or reproduction. A data stream from the coder cannot be stored in the buffer that should store data streams including audiovisual data, resulting in a missing frame in the audiovisual data.

To prevent repeated audiovisual data or a missing frame on the decoder as mentioned above, the MPEG2-TS standard requires the decoder to provide a PLL (Phase Locked Loop) integrated with the STC for complete correspondence between the coder's system clock and the decoder's STC frequency. The decoder's PLL generates a clock having a frequency completely matching that of the coder based on the difference between a value of the PLL's reference time counter and the PCR embedded in a compressed data stream. Since the PCR is used to correct the STC, the decoder can synchronously reproduce the video and audio at the timing intended on the coder. For MPEG2, the system clock is 27 MHz and an error of up to 810 Hz is allowed.

Recently, there has been an increasing demand for a capability of transferring audiovisual data encoded at a plurality of remote locations via networks and receiving and decoding a plurality of data streams at a receiving site, for example, to implement a TV conference system, video chatting, etc.

When prior art is used to satisfy the above-mentioned demand, a plurality of data streams, according to the MPEG2-TS system, are transferred to the decoder. In this case, the decoder requires a plurality of PLLs for correcting the decoder's STC at a timing intended on the coder with respect to all data streams. However, this increases decoder costs. When the respective data streams are output to a plurality of monitors, the plurality of PLLs can correct the reference time for each of the data streams and reproduce the data streams at a plurality of reference frequencies. When a single monitor is used for simultaneously reproducing a plurality of data streams, a single reference frequency must be used for reproduction. All data streams cannot be reproduced according to the corresponding time information.

The technology for satisfying the above-mentioned demand is disclosed in JPA No. 5499/2001. According to the technology, the decoder is provided with a reference time information selection section that obtains the PCR of each data stream from a plurality of data streams and selects one of the PCRs. The decoder according to the technology uses the PCR selected in the reference time information selection section to correct the STC.

When this technology is used, the decoder cannot reproduce a data stream other than selected ones at the correct time. In an environment where a jitter or a packet loss occurs for networks, wireless communications, etc., the technology complicates processing of the reference time information selection for decreasing reproduction anomalies due to reference frequency differences. Even when a single data stream is transferred, PCR data is received incompletely due to a jitter or a packet loss on the network. The decoder cannot reproduce data at proper timing.

### BRIEF SUMMARY OF THE INVENTION

This invention provides a data stream coder and decoder capable of allowing the decoder to reproduce data streams transmitted from one or many coders at proper timing. To achieve this, in one aspect, a data stream processor is configured to have a reference frequency control section supplied with time information from outside the apparatus; and a data stream control section to input and output a data stream based on a signal generated from the reference frequency control section.

In another aspect, the reference frequency control section may be configured to have a reference time information acquisition section supplied with the time information; an oscillator to generate a signal for determining a frequency in the data stream processing section; and an oscillator control section to calculate a difference between time information input to the reference time information acquisition section and an frequency of a signal generated from the oscillator and to control the oscillator based on the calculation result.

In still another aspect, the data stream processing section may be configured to have a data stream storage section to store an externally supplied data stream; and a data stream processing section to process a data stream stored in the data stream storage section and output the data stream to the outside.

In yet another aspect, the data stream processing section may be configured to comprise: a data stream demultiplexing section to separate data supplied from the data stream storage section into video encoding information and audio encoding information; a video decoder section to generate video data from the video encoding information supplied from the data stream demultiplexing section; an audio decoder section to generate audio data from the audio encoding information supplied from the data stream demultiplexing section; a video selection/synthesis section to select and synthesize the video data for external output; and an audio selection/synthesis section to select and synthesize the audio data for external output.

In another aspect, the data stream storage section may be configured to have a video storage section to store an externally supplied video data stream and an audio storage section to store an externally supplied audio data stream; and the data stream processing section may be configured to have a video encoder section to generate video encoding information from the video data, an audio encoder section to generate video encoding information from the audio data, and a stream multiplexing section to multiplex the video encoding information and the audio encoding information and generate a data stream. The time information may be transmitted from an NTP server.

Other and further objects, features and advantages of the invention will appear more fully from the following description.

### BRIEF DESCRIPTION OF THE DRAWINGS

FIG. 1 shows a configuration of a data stream processor according to the present invention;

FIG. 2 shows a configuration of a data stream decoder according to the present invention;

FIG. 3 shows another configuration of a data stream coder according to the present invention;

FIG. 4 shows another configuration of a data stream decoder according to the present invention;

FIG. 5 shows yet another configuration of a data stream decoder according to the present invention;

FIG. 6 shows a configuration of a register to store;

FIG. 7 shows a configuration of the data stream processor according to the present invention connected to a network;

FIG. 8 shows another configuration of the data stream processor according to the present invention connected to a network;

FIG. 9 shows another configuration of a data stream coder/decoder according to the present invention; and

FIG. 10 shows an NTP format.

### DETAILED DESCRIPTION OF THE INVENTION

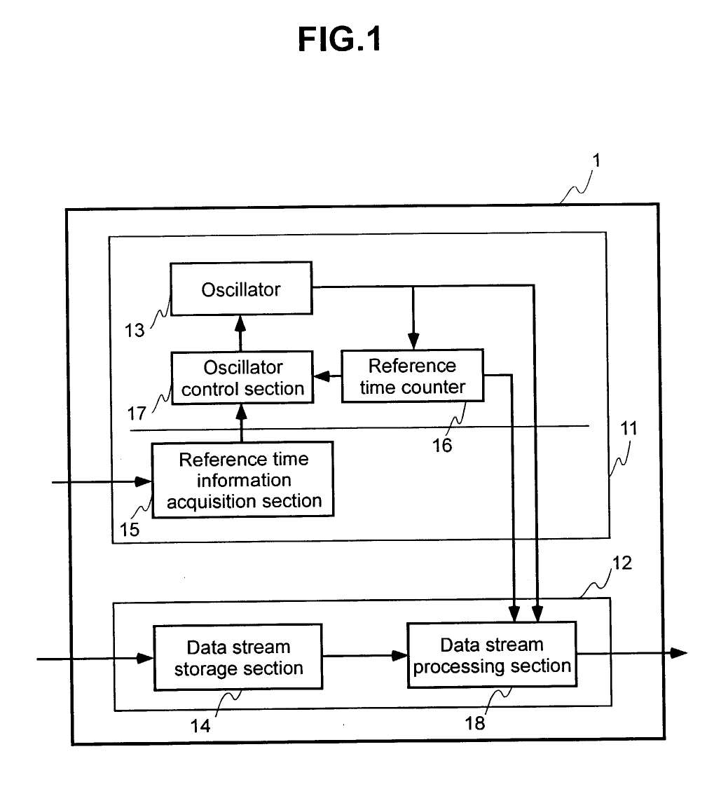

FIG. 1 shows a configuration of a data stream processor 1 according to a preferred embodiment of the present invention. The term data stream processor is used herein as a generic name for a data coder, a data decoder, and a data coder/decoder. Data stream processor 1 has a reference frequency control section 11 and a data stream control section 12. Reference frequency control section 11 provides a reference frequency that defines timings for data transmission etc. in the apparatus based on time information supplied from the outside of data stream processor 1. Data stream control section 12 temporarily stores an externally supplied data stream and outputs the data stream based on the reference frequency determined by a signal generated from reference frequency control section 11. Reference frequency control section 11 includes an oscillator 13, a reference time counter 16, an oscillator control section 17, and a reference time information acquisition section 15.

Reference time counter 16 is incremented synchronously with the reference frequency (27 MHz in this embodiment) defined by a clock signal generated from oscillator 13. Oscillator control section 17 controls oscillator 13 using a difference between a value of reference time counter 16 and the external time information obtained by reference time information acquisition section 15. The NTP (Network Time Protocol) is an example of the time information obtained by reference time information acquisition section 15.

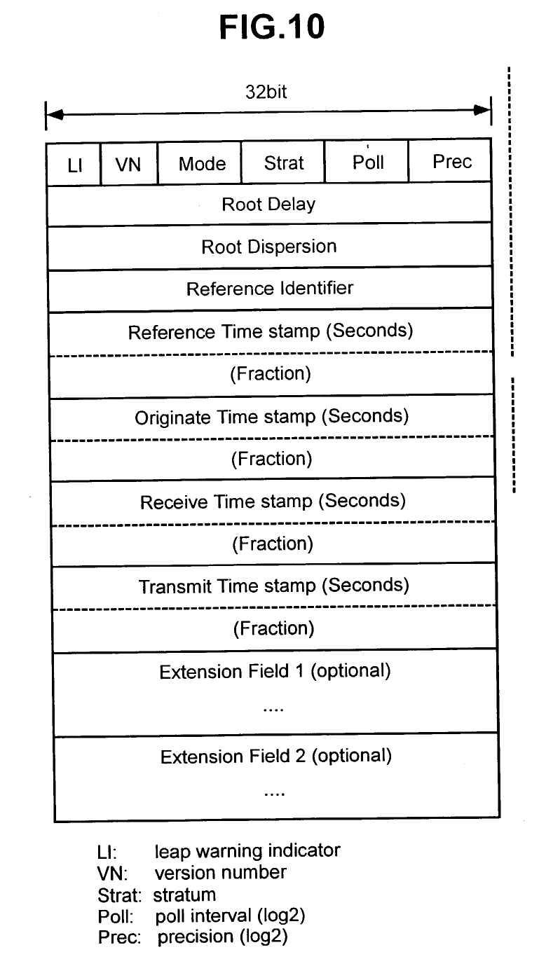

FIG. 10 is a diagram of an NTP format. The NTP time information is a 2³² Hz (approximately 4 GHz) counter value comprised of the number of seconds (32 bits representing time since Jan. 1, 1900 and the fractional portion (32 bits) of a second. Oscillator control section 17 holds the NTP external time information and a value of reference time counter 16 when the NTP was obtained. Thereafter, oscillator control section 17 compares next obtained NTP time information and a value of reference time counter 16 at that time with the previously stored time information and the value of reference time counter 16 to compute each increase. Further, oscillator control section 17 compares an increase in the NTP time information with an increase in the value of reference time counter 16 and controls oscillator 13 according to the difference.

Data stream control section 12 includes a data stream storage section 14 to store an externally supplied data stream, and a data stream processing section 18 to process a data stream stored in data stream storage section 14 for output. Data stream processing section 18 externally outputs a processed data stream according to the clock signal generated from oscillator 13.

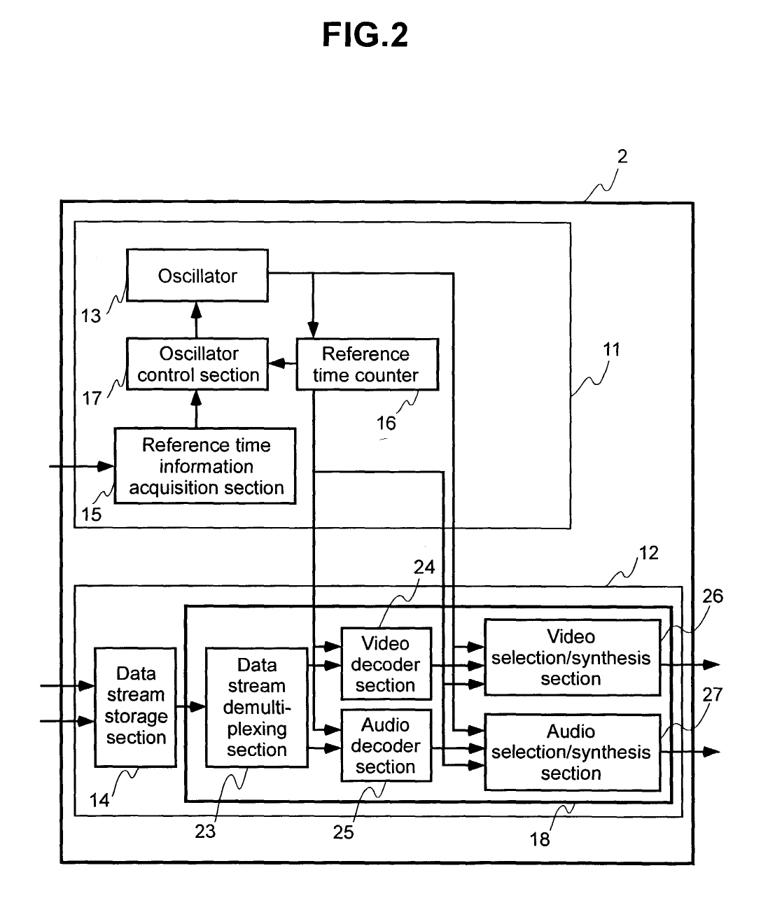

FIG. 2 illustrates an embodiment in which data stream processor 1, explained in FIG. 1, is used as a data stream decoder 2. In data decoder 2, data stream processing section 18 of data stream control section 12 has a data stream demultiplexing section 23, a video decoder section 24, an audio decoder section 25, a video selection/synthesis section 26, and an audio selection/synthesis section 27. The configuration of reference frequency control section 11 is the same as that in FIG. 1.

Data stream storage section 14 stores an externally supplied data stream (MPEG2-TS in this embodiment). Data stream demultiplexing section 23 extracts video encoding information (video stream, PTS, and DTS), and audio encoding information (audio stream, PTS, and DTS) from a data stream supplied from data stream storage section 14. Data stream demultiplexing section 23 outputs the extracted video encoding information to video decoder section 24 and the extracted audio encoding information to audio decoder section 25. In the embodiment, the PCR contained in a data stream is not used for control of the reference frequency.

Video decoder section 24 stores video encoding information supplied from data stream demultiplexing section 23 in a buffer of video decoder section 24. Thereafter, video decoder section 24 starts decoding video data at the timing when the count value (STC) of reference time counter 16 becomes equal to the DTS contained in the data. The generated video data is output to video selection/synthesis section 26.

On the other hand, audio decoder section 25 decodes audio encoding information supplied from data stream demultiplexing section 23 at the timing when the STC becomes equal to the DTS contained in the data. The generated audio data is output to audio selection/synthesis section 27.

Video selection/synthesis section 26 selects video data a user requests to display from a plurality of video data supplied from video decoder section 24. Video selection/synthesis section 26 stores a value added by weighting each video data at a specified location in a video data storage area corresponding to one frame provided for output to a display device such as a monitor, and thus synthesizes a plurality of video data. Thereafter, video selection/synthesis section 26 outputs the synthesized video data as a video signal at the timing when the count value (STC) of reference time counter 16 becomes equal to the PTS contained in the data.

Similarly, audio selection/synthesis section 27 selects audio data a user requests to display from a plurality of audio data supplied from audio decoder section 25. Audio selection/synthesis section 27 stores a value added by weighting each audio data's frequency level or output level at a specified location in an audio data storage area corresponding to one frame provided for output to an audio device such as a speaker, and thus synthesizes a plurality of audio data.

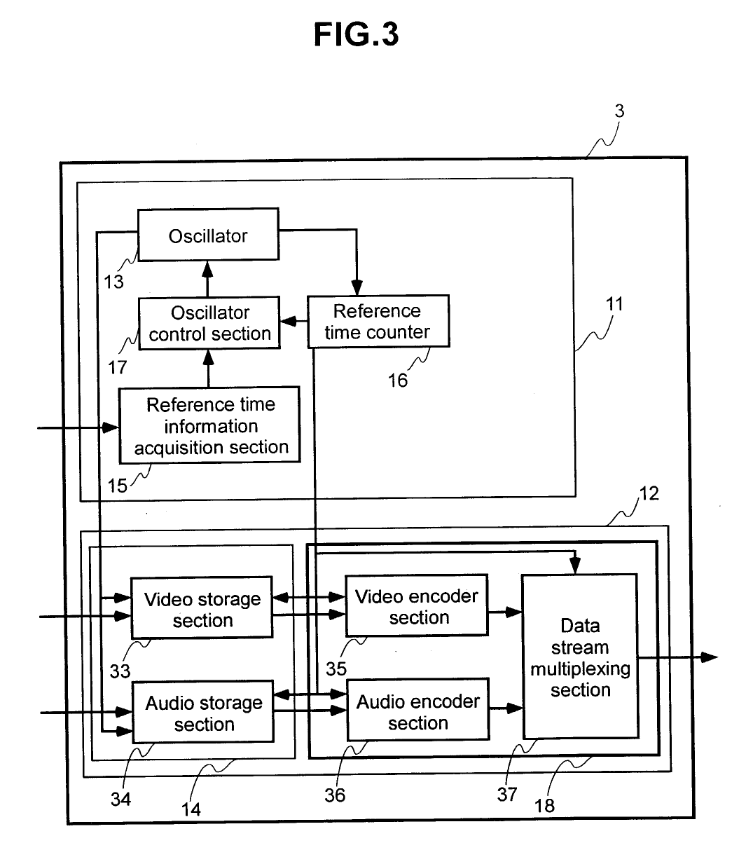

FIG. 3 illustrates a configuration for using data stream processor 1 in FIG. 1 as a data stream coder 3. Data stream storage section 14 comprises a video storage section 33 and an audio storage section 34. Data stream processing section 18 comprises a video encoder section 35, an audio encoder section 36, and a data stream multiplexing section 37. Reference frequency control section 11 is the same as that in FIG. 1.

Video storage section 33 stores an externally input data stream, specifically a video signal, as video data. Audio storage section 34 stores an externally input audio signal as audio data. Video encoder section 35 encodes video data supplied from video storage section 33 to generate video encoding information. Audio encoder section 36 encodes audio data supplied from audio storage section 34 to generate audio encoding information.

Data stream multiplexing section 37 generates PTS, DTS, and PCR based on a value of reference time counter 16. Data stream multiplexing section 37 generates a data stream from these pieces of time information, video encoding information, and audio encoding information, and outputs the data stream to the outside.

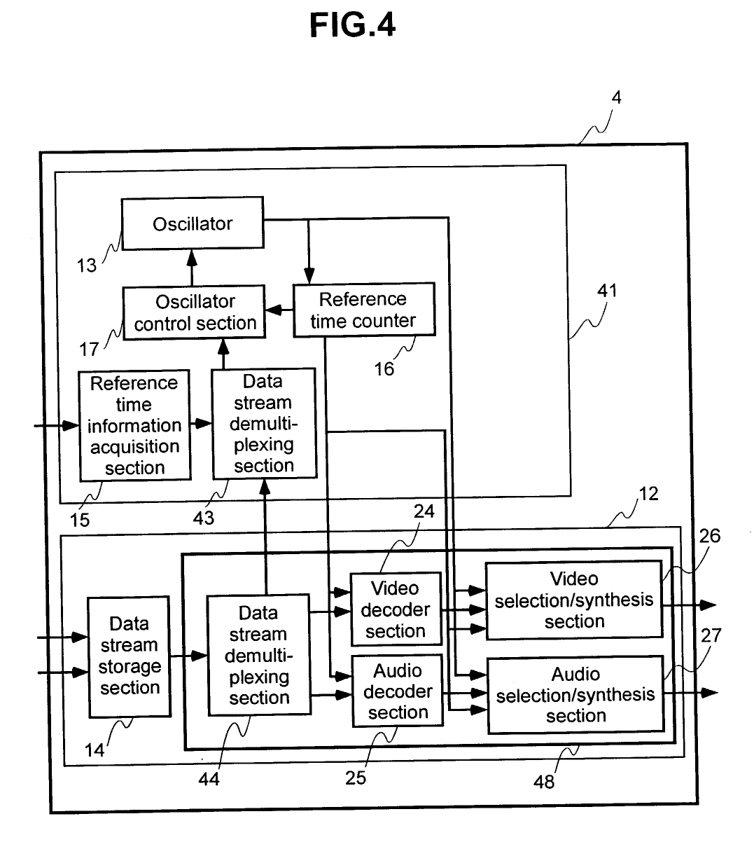

FIG. 4 shows a configuration of the data stream decoder according to another embodiment. The embodiment corrects the reference frequency even if reference time information acquisition section 15 cannot obtain external time information. It is possible to minimize a phenomenon in which a coder's intended time gradually deviates from the encoder's STC.

The reference frequency control section 41 differs from reference frequency control section 11 of FIG. 1 in that the former has a reference time information selection section 43. Data stream control section 48 differs from data stream demultiplexing section 18 described with reference to FIG. 2 in the function of a data stream demultiplexing section 44.

Data stream demultiplexing section 44 extracts the PCR from each of a plurality of input data streams and outputs the PCR to reference time information selection section 43. Reference time information selection section 43 selects either the PCR or time information supplied from reference time information acquisition section 15 and outputs it to oscillator control section 17. When no time information is supplied from reference time information acquisition section 15, reference time information selection section 43 selects the PCR supplied from data stream demultiplexing section 44. The case of no time information supplied means that no external time information is input over the threshold value for a time interval provided in the apparatus. When no external time information is supplied, reference time information selection section 43 selects the PCR.

According to the embodiment, if reference time information acquisition section 15 cannot obtain the external reference time information for some reason, data stream decoder 4 can select the PCR extracted in data stream demultiplexing section 43. This makes it possible to decrease errors during reproduction to a certain degree.

FIG. 7 shows an embodiment of a configuration that connects data stream coder 3 and data stream decoder 2 to a network. A network 61 connects with a reference time station 62 in addition to data stream coder 3 and data stream decoder 2. The time information supplied from reference time station 62 is obtained by reference time information acquisition section 15 provided for each of data stream coder 3 and data stream decoder 2. Based on the obtained time information, data stream coder 3 and data stream decoder 2 correct respective reference frequencies so that each of reference frequencies equals the reference frequency of reference time station 62. When a plurality of data stream coders 3 is available as shown in FIG. 7, there occurs no deviation between reference frequencies for data stream coder 3 and data stream decoder 2. This can prevent an error due to deviation of reference frequency while data stream decoder 2 reproduces data.

As reference base station, it is possible to use an ordinary host computer, a GPS (Global Positioning Satellite), an NTP server, etc. The NTP server is a server used for the technology that synchronizes the time between computers connected to the Internet. A computer connected to the Internet can adjust its own time setting by using NTP servers scattered worldwide. When a server also works as the NTP server, each client can use this server to adjust its own time setting to the same system time as for the NTP server. The NTP technology can keep a time difference between the reference base station and each computer within tens of milliseconds. When an NTP server is used for the reference time station, it is possible to always keep an error between the reference time for the coder and that for the decoder within tens of milliseconds.

When reference time information acquisition section 15 obtains time information supplied from the NTP server, however, the information may contain an error of tens of milliseconds as mentioned above. In this case, if data stream decoder 2 controls oscillator 13 using a set of time information and the counter value, the reference frequency may not be stabilized.

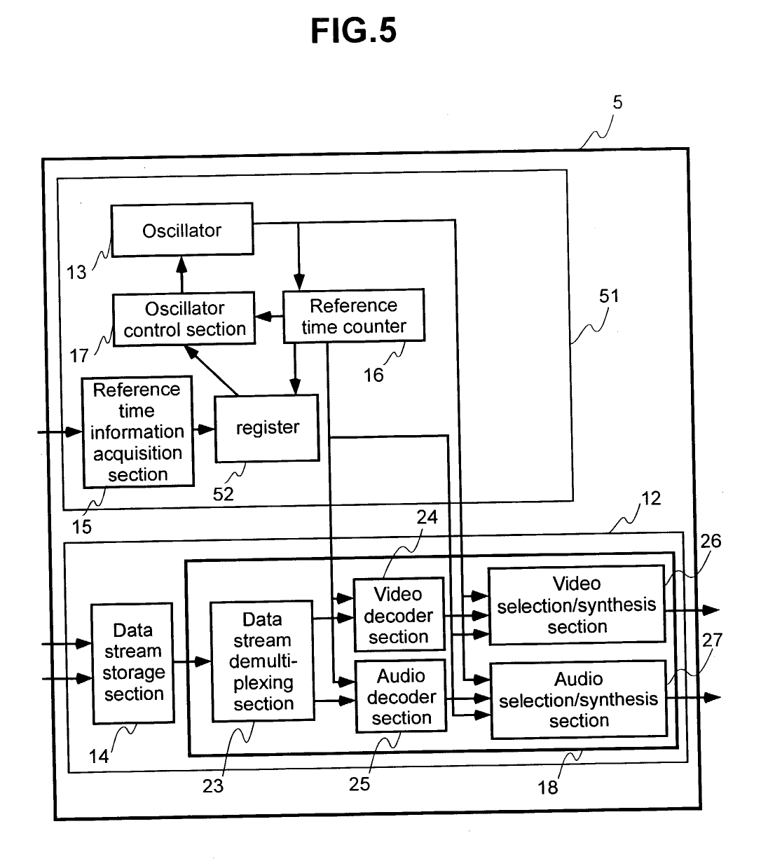

FIG. 5 shows an embodiment of data stream decoder 5 for solving the above-mentioned problem. A reference frequency control section 51 differs from reference frequency control section 11 in that the former has a register 52.

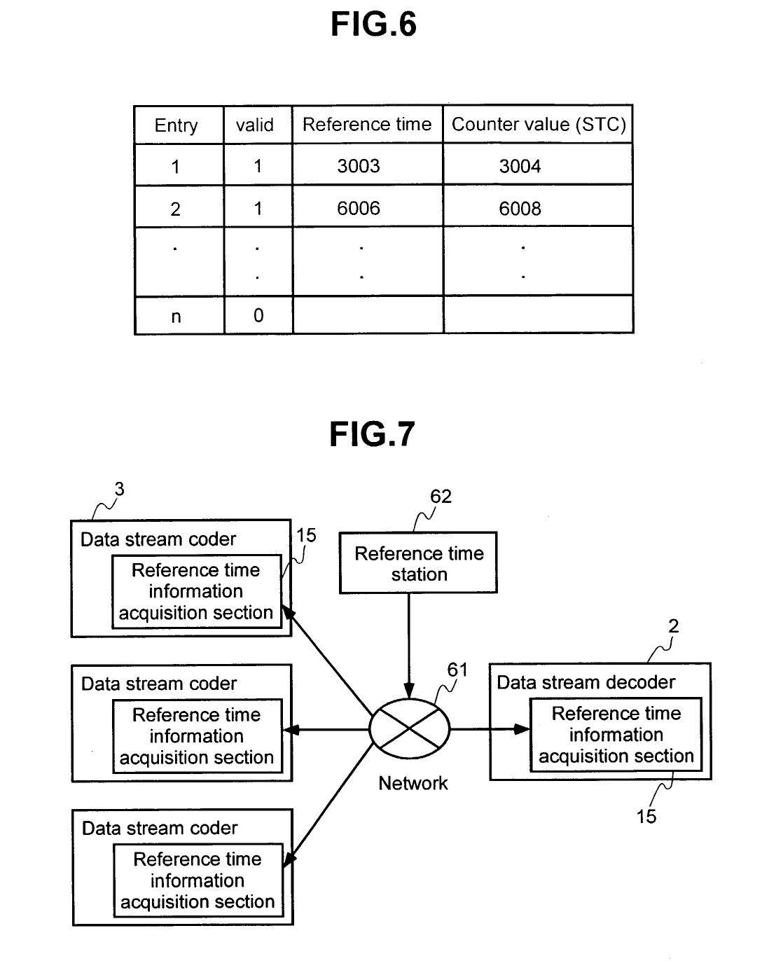

When obtaining external reference time information, reference time information acquisition section 15 registers reference time information and a value of reference time counter 16 to register 52. As shown in FIG. 6, register 52 is configured to store a history of reference time and counter values. Based on this history, reference frequency control section 51 can determine an increasing tendency for the reference time and counter values. Oscillator control section 17 controls oscillator 13 based on the increasing tendency determined from the history of reference time and counter values stored in register 52. For example, oscillator control section 17 finds average values for increased time intervals corresponding to the reference time and the counter value and controls oscillator 13 according to a difference between these average values.

According to the embodiment, data stream decoder 5 analyzes an increasing tendency of the reference time and counter values to control oscillator 13 based on the history of the reference time and counter values stored in register 52. Consequently, data stream decoder can generate a clock signal with more decreased reference frequency fluctuations.

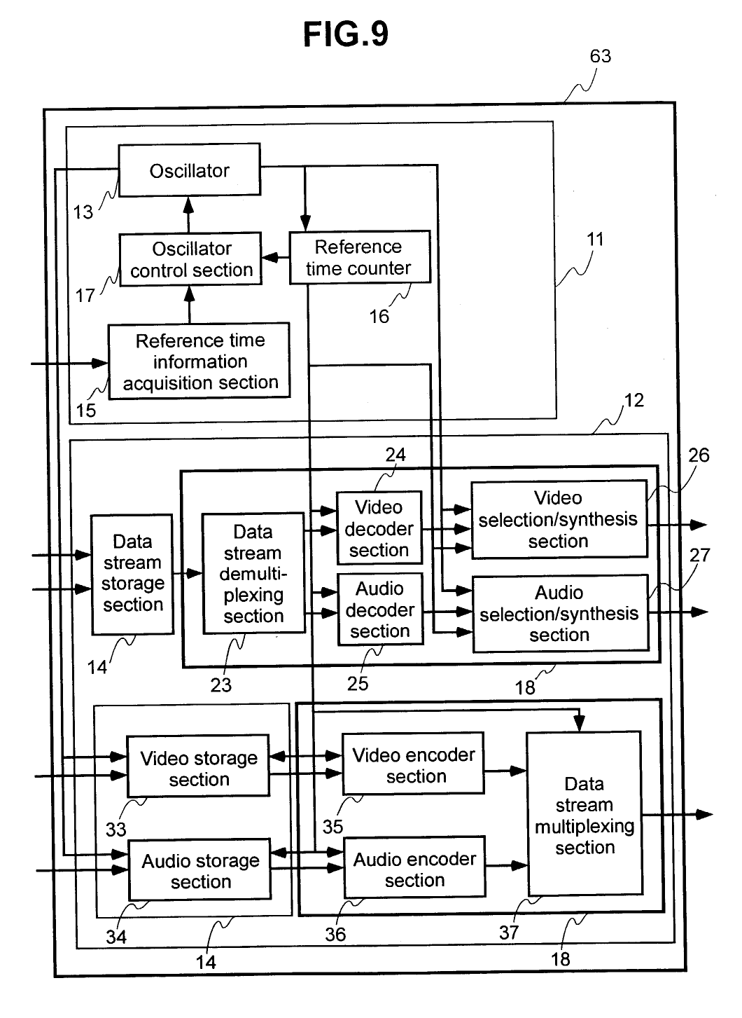

FIG. 9 shows a configuration of a data stream coder/decoder 63 according to the present invention. A data stream coder/decoder 63 has reference frequency control section 11 and data stream control section 12. The configuration of reference frequency control section 11 is the same as those in FIGS. 2 and 3. Data stream control section 12 has data stream storage section 14 and data stream processing section 18 in FIG. 2 for decoding; and data stream storage section 14 and data stream processing section 18 in FIG. 3 for encoding. A data stream coder/decoder 63 uses one reference frequency control section 11 to send the reference frequency to encoding portions and decoding portions.

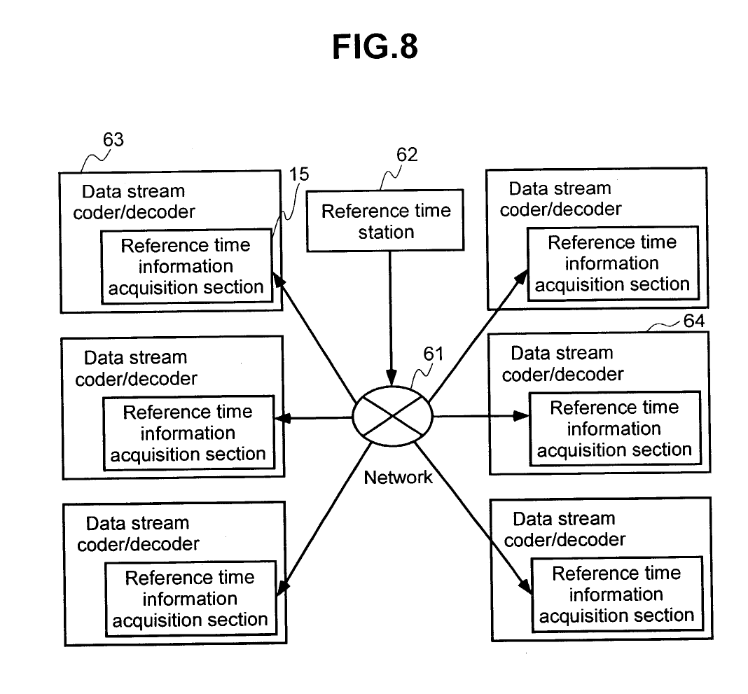

FIG. 8 shows a system connecting a plurality of data stream coders/decoders shown in FIG. 9 to network 61. This configuration can transfer an audiovisual data stream encoded in the local apparatus. Remotely located apparatuses can interchange a plurality of encoded audiovisual data streams with each other. This makes it possible to decrease occurrences of repetition or loss of audiovisual data in bidirectional communication systems such as a TV conference system, video chatting, etc.

When a single data stream cannot be transferred from another apparatus, a problem arises according to the prior art if it uses the reference time in that data stream. The system according to the present invention does not cause such a problem because the reference time is externally obtained. Even if one or more data streams are received and are displayed on a display apparatus, the present invention can solve the problem of repeated or missing audiovisual data due to a reference frequency difference between the coder side and the decoder side.

The foregoing invention has been described in terms of preferred embodiments. However, those skilled, in the art will recognize that many variations of such embodiments exist. Such variations are intended to be within the scope of the present invention and the appended claims.

What is claimed is:

1. A data stream processor comprising:
a reference frequency control section supplied with time information from outside of the data stream processor; and
a data stream control section to input and output a data stream based on a signal generated from the reference frequency control section.

2. The data stream processor according to claim 1, wherein the reference frequency control section comprises:
a reference time information acquisition section supplied with the time information;
an oscillator to generate a signal defining a frequency in the data stream processing section; and
an oscillator control section connected to control the oscillator based on a difference between time information input to the reference time information acquisition section and a frequency of a signal generated from the oscillator.

3. The data stream processor according to claim 2, wherein
the reference frequency control section has a reference time counter to count frequencies determined by a signal output from the oscillator and to output a reference time; and
the oscillator control section controls the oscillator so as to eliminate a difference between the time information and the reference time.

4. The data stream processor according to claim 1 wherein the data stream processing section has a data stream storage section to store a an externally supplied data stream, and the data stream processing section processes a data stream stored in the data stream storage section and outputs the data stream.

5. The data stream processor according to claim 4, wherein the data stream processing section comprises:
a data stream demultiplexing section to separate a data stream supplied from the data stream storage section into video encoding information and audio encoding information;
a video decoder section to generate video data from the video encoding information supplied from the data stream demultiplexing section;
an audio decoder section to generate audio data from the audio encoding information supplied from the data stream demultiplexing section;
a video selection/synthesis section to select and synthesize the video data for external output; and
an audio selection/synthesis section to select and synthesize the audio data for external output.

6. The data stream processor according to claim 5 wherein the reference frequency control section has a reference time information selection section to select one of reference time information extracted by the data stream demultiplexing section and time information obtained by the reference time information acquisition section and to output the selected information to the oscillator control section.

7. The data stream processor according to claim 6, wherein the reference frequency control section has a register to store a history of the time information and the reference time counter.

8. The data stream processor according to claim 4, wherein:
the data stream storage section has a video storage section to store an externally supplied video data stream and an audio storage section to store an externally supplied audio data stream; and
the data stream processing section has a video encoder section to generate video encoding information from the video data stream, an audio encoder section to generate video encoding information from the audio data stream, and a stream multiplexing section to multiplex the video encoding information and the audio encoding information and generate a data stream.

9. The data stream processor according to claim 1 wherein the time information is transmitted from an NTP server.

10. A recording medium storing a data stream processing program to process externally supplied data, wherein:
the program counts externally supplied reference time information and a reference frequency supplied from an oscillator, obtains a value of a reference time counter to output a reference time, and controls an adjustment signal for the oscillator so as to decrease differences of variations in both values.

11. A function interface for the data stream processing program, wherein the program uses reference time information and a reference time counter as function arguments for registering reference time information and the reference time counter to a history

12. A function interface for the data stream processing program wherein the program uses reference time information and the reference time counter as global variables for registering the reference time information and the reference time counter to a history.
